(19) United States
(12) Patent Application Publication
(10) Pub. No.: US 2010/0235750 A1
(43) Pub. Date: Sep. 16, 2010

(54) SYSTEM, METHOD AND PROGRAM PRODUCT FOR A GRAPHICAL INTERFACE

(76) Inventor: Bryce Douglas Noland, Bellvue, CO (US)

Correspondence Address: Bryce Douglas Noland, Unit D248, 1281 E. Magnolia St., Fort Collins, CO, 80524, US

(21) Appl. No.: 12/403,268

(22) Filed: Mar. 12, 2009

(51) Int. Cl. G06F 15/177

(52) U.S. Cl. 715/735; 715/736; 709/223; 709/221

(57) ABSTRACT

A system for a graphical user interface for network applications and network resources includes a workspace application unit for presenting to a user, the network applications and network resources within a workspace area where the user can interact with the network applications and network resources to perform tasks. A configuration unit organizes the network applications and network resources within the workspace area according to stored preferences, maintains network links to the network applications and network resources, maintains current states of the network applications and configures devices according to stored preferences for the user to interact with the network applications and network resources. At least one rendering unit renders the network applications and network resources for display in the workspace area.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates to computer software and internet technologies. More specifically the invention relates to a user interface, internet browser, internet application and internet hosting technologies.

### BACKGROUND OF THE INVENTION

The Internet and World Wide Web is increasingly being used as an application platform rather than its previously traditional role as a delivery mechanism for hypertext documents (i.e., web pages). With the Internet becoming more of an application platform, users have many sites that they access on a daily basis, through their web browsers, in order to carry out their work, play and/or socializing. Typically, the majority of the processing and data storage functions for web pages are performed on the host servers of these web pages, and a user interface is typically acted on by the user using a web browser.

Currently users interact with their web browsers in order to access all of their web content and applications. Anytime the user accesses these sites or applications from a different computer, their working environment may not be entirely the same. For example, their user preferences such as, but not limited to, shortcut keys or screen layout may be different. Furthermore, the computer may have a different operating system or different web browser, which changes their overall experience and may require some retraining for the user to be productive. The user may even have to remember where and which sites are hosting all of their applications. Currently some internet applications store data locally on the user's computer. Usually the applications are in the form of cookies or other supported internet browser temporary files.

In view of the foregoing, there is a need for improved techniques for providing means for a user to use applications and resources that reside on a network that the user is able to access from any computer and that provide the same user preferences, settings, appearance, and interaction regardless of which computer the user is operating.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrate an exemplary system for providing a workspace application hosted on a server, in accordance with an embodiment of the present invention. FIG. 1A is a block diagram showing the components of the exemplary workspace application system, and FIG. 1B shows a computer network on which the workspace application may be used;

FIGS. 2A and 2B illustrate an exemplary system for providing a workspace application installed locally on a network connected computer, in accordance with an embodiment of the present invention. FIG. 2A is a block diagram showing the components of the exemplary workspace application system, and FIG. 2B shows a computer network on which the workspace application may be used;

FIGS. 3A and 3B illustrate an exemplary system for providing a workspace application where the workspace application is used as a user interface component of an operating system of a computing device, in accordance with an embodiment of the present invention. FIG. 3A is a block diagram showing the components of the exemplary workspace application system, and FIG. 3B shows a network on which the workspace application may be used;

FIGS. 4A and 4B illustrate an exemplary system for providing a workspace application where the workspace application is installed on an external portable storage device, in accordance with an embodiment of the present invention. FIG. 4A is a block diagram showing the components of the exemplary workspace application system, and FIG. 4B shows a computer network on which the workspace application may be used;

FIGS. 5A and 5B illustrate exemplary workspace layouts, in accordance with embodiments of the present invention. FIG. 5A shows an exemplary three dimensional workspace layout, and FIG. 5B shows an exemplary two dimensional workspace layout; and

FIG. 6 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a system, method and program product for a graphical interface is presented.

In one embodiment, a system for a graphical user interface for network applications and network resources is presented. The system includes a workspace application unit for presenting to a user, the network applications and network resources within a workspace area where the user can interact with the network applications and network resources to perform tasks. A configuration unit organizes the network applications and network resources within the workspace area according to stored preferences, and maintains network links to the network applications and network resources. At least one rendering unit renders the network applications and network resources for display in the workspace area. In another embodiment the configuration unit further maintains current states of the network applications. In another embodiment the configuration unit further configures devices according to stored preferences for the user to interact with the network applications and network resources. Another embodiment further includes additional rendering units for rendering the network applications and network resources for display in the workspace area. In another embodiment the configuration unit further maintains security levels for the network applications and network resources to control sharing of workspace area between users. In yet another embodiment the network applications and network resources are displayed in a 3-D aspect. In still another embodiment the interface is hosted by a computing device on a network where the configuration unit stores the preferences, network links, current states on a storage device associated with the computing device, and where the interface can be accessed by a plurality of computing devices on the network to provide a substantially same environment on each of the plurality of computing devices. In another embodiment the interface is stored on a persistent portable memory device where the configuration unit stores the preferences, network links, current states on the persistent portable memory device, and where the interface can be accessed by a plurality of computing devices using the persistent portable memory device to provide a substantially same environment on each of the plurality of computing devices. In yet another embodiment the interface serves as a primary interface for an operating system on a computing device.

In another embodiment a system for a graphical user interface for network applications and network resources is presented. The system includes means for presenting to a user, the network applications and network resources within a workspace area, means for organizing the network applications and network resources within the workspace area, maintaining network links, and means for rendering the network applications and network resources for display in the workspace area. Another embodiment further includes means for maintaining current states of the network applications. Another embodiment further includes means for configuring devices according to stored preferences for the user to interact with the network applications and network resources. Another embodiment further includes means for maintaining security levels for the network applications and network resources. Yet another embodiment further includes means for accessing the interface by a plurality of computing devices on a network to provide a substantially same environment on each of the plurality of computing devices. Still another embodiment further includes means for accessing the interface by a plurality of computing devices using a persistent portable memory device to provide a substantially same environment on each of the plurality of computing devices. Yet another embodiment further includes means for serving as a primary interface for an operating system on a computing device.

In another embodiment a method for a graphical user interface for network applications and network resources is presented. The method includes the step of activating a workspace application for presenting to a user, the network applications and network resources within a workspace area where the user can interact with the network applications and network resources to perform tasks. The method includes the step of receiving configuration data for organizing the network applications and network resources within the workspace area according to stored preferences, and maintaining network links to the network applications and network resources. The method further includes the step of receiving rendered network applications and network resources for display in the workspace area. Another embodiment further includes the step of receiving configuration data for maintaining current states of the network applications. Another embodiment further includes the step of receiving configuration data for configuring devices according to stored preferences for the user to interact with the network applications and network resources. Another embodiment further includes the step of receiving rendered network applications and network resources from additional rendering units for display in the workspace area. Yet another embodiment further includes the step of receiving configuration data for maintaining security levels for the network applications and network resources to control sharing of workspace area between users. Still another embodiment further includes the step of receiving rendered network applications and network resources for display in a 3-D aspect. In another embodiment the interface is hosted by a computing device on a network where the method further includes the steps of storing and retrieving the configuration data on a storage device associated with the computing device, where a plurality of computing devices can activate the workspace application and receive the configuration data to provide a substantially same environment on each of the plurality of computing devices. In yet another embodiment the interface is stored on a persistent portable memory device where the method further includes the steps of storing and retrieving the configuration data on the persistent portable memory device, where a plurality of computing devices, using the persistent portable memory device, can activate the workspace application and receive the configuration data to provide a substantially same environment on each of the plurality of computing devices. In still another embodiment the interface serves as a primary interface for an operating system on a computing device.

In another embodiment a method for a graphical user interface for network applications and network resources is presented. The method includes steps for presenting to a user, the network applications and network resources within a workspace area, steps for organizing the network applications and network resources within the workspace area, and maintaining network links. Another embodiment further includes steps for maintaining current states of the network applications. Another embodiment further includes steps for configuring devices and steps for displaying the network applications and network resources in the workspace area. Another embodiment further includes steps for maintaining security levels for the network applications and network resources. Yet another embodiment further includes steps for accessing the interface by a plurality of computing devices on a network to provide a substantially same environment on each of the plurality of computing devices. Still another embodiment further includes steps for accessing the interface by a plurality of computing devices using a persistent portable memory device to provide a substantially same environment on each of the plurality of computing devices. Yet another embodiment further includes steps for serving as a primary interface for an operating system on a computing device.

In another embodiment a graphical user interface for network applications and network resources is presented. The interface includes a workspace application unit for presenting to a user, the network applications and network resources within a workspace area where the user can interact with the network applications and network resources to perform tasks. A configuration unit organizes the network applications and network resources within the workspace area according to stored preferences, and maintains network links to the network applications and network resources. At least one rendering unit renders the network applications and network resources for display in the workspace area. In another embodiment the configuration unit further maintains current states of the network applications. In another embodiment the configuration unit further configures devices according to stored preferences for the user to interact with the network applications and network resources. Another embodiment further includes additional rendering units for rendering the network applications and network resources for display in the workspace area. In yet another embodiment the configuration unit further maintains security levels for the network applications and network resources to control sharing of workspace area between users. In still another embodiment the network applications and network resources are displayed in a 3-D aspect. In another embodiment the interface is hosted by a computing device on a network where the configuration unit stores the preferences, network links, current states on a storage device associated with the computing device, and where the interface can be accessed by a plurality of computing devices on the network to provide a substantially same environment on each of the plurality of computing devices. In yet another embodiment the interface is stored on a persistent portable memory device where the configuration unit stores the preferences, network links, current states on the persistent portable memory device, and where the interface can be accessed by a plurality of computing devices using the persistent portable memory device to provide a substantially same environment on each of the plurality of computing devices. In still another embodiment the interface serves as a primary interface for an operating system on a computing device.

In another embodiment a graphical user interface for network applications and network resources is presented. The interface includes means for presenting to a user, the network applications and network resources within a workspace area, means for organizing the network applications and network resources within the workspace area, maintaining network links, and means for rendering the network applications and network resources for display in the workspace area. Another embodiment further includes means for maintaining current states of the network applications. Another embodiment further includes means for configuring devices. Another embodiment further includes means for maintaining security levels for the network applications and network resources. Yet another embodiment further includes means for accessing the interface by a plurality of computing devices on a network to provide a substantially same environment on each of the plurality of computing devices. Another embodiment further includes means for accessing the interface by a plurality of computing devices using a persistent portable memory device to provide a substantially same environment on each of the plurality of computing devices. Still another embodiment further includes means for serving as a primary interface for an operating system on a computing device.

In another embodiment a computer program product for a graphical user interface for network applications and network resources is presented. The computer program product includes computer code for presenting to a user, the network applications and network resources within a workspace area where the user can interact with the network applications and network resources to perform tasks. Computer code organizes the network applications and network resources within the workspace area according to stored preferences, and maintains network links to the network applications and network resources. Computer code displays rendered network applications and network resources in the workspace area. A computer-readable medium stores the computer code. Another embodiment further includes computer code for displaying network applications and network resources, rendered from a plurality rendering units, in the workspace area. Another embodiment further includes computer code for maintaining current states of the network applications. Another embodiment further includes computer code for configuring devices according to stored preferences for the user to interact with the network applications and network resources. Yet another embodiment further includes computer code for maintaining security levels for the network applications and network resources to control sharing of workspace area between users. Still another embodiment further includes computer codes for displaying rendered network applications and network resources in the workspace area in a 3-D aspect. In another embodiment the computer program product is hosted by a computing device on a network where the computer program product further includes computer code for storing and retrieving configuration data on a storage device associated with the computing device, where a plurality of computing devices can access the computer program product and receive the configuration data to provide a substantially same environment on each of the plurality of computing devices. In still another embodiment the computer program product is stored on a persistent portable memory device and the computer program product further includes computer code for storing and retrieving configuration data on the persistent portable memory device where a plurality of computing devices, using the persistent portable memory device, can access the computer program product and receive the configuration data to provide a substantially same environment on each of the plurality of computing devices. In yet another embodiment the computer program product serves as a primary interface for an operating system on a computing device and the computer program product further includes computer code for communicating with a kernel of the operating system.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Preferred embodiments of the present invention provide users with a workspace in which to interact with their applications and resources that reside on a network. In some preferred embodiments, users are able to access this workspace from any computer with the same user preferences, settings, appearance, and interaction regardless of which computer they are operating. In preferred embodiments the workspace is configurable and provides a graphical user interface that enables the user to organize any network/internet based applications that they desire. User configuration in preferred embodiments includes, without limitation, the position and size of the applications and resources, whether the user wants the application automatically loaded and shown in a window, automatically logged in or shown as an icon or image marker, etc. In preferred embodiments the user may also set user preferences that may include, without limitation, keyboard shortcuts, fonts, styles, backgrounds, etc.

The terms defined as follows are used throughout the present description, and it is to be understood that these terms are herein to convey the definitions provided at this time. A Uniform Resource Identifier (URI) is a compact string of characters used to identify or name a resource on the Internet. The main purpose of this identification is to enable interaction with representations of the resource over a network, typically the World Wide Web, using specific protocols. Web-rendering technologies are technologies that present applications and resources to users via a network or the Internet. The rendering is typically handled by a web-browser. Examples include, without limitation, HTML, DHTML, XML, CSS, XSL, javascript, vbscript, Flash, Silverlight, etc. Persistent memory or non-volatile storage is a term describing storage whose contents are preserved when the power is off on the device on which the storage resides.

In preferred embodiments, the workspace enables users to interact and use any internet or network based application that they desire. Preferred embodiments provide a single place for users to organize their workspaces with all of their applications and internet/network resources that they desire to use. Software in preferred embodiments may be used on existing computers, hosted within existing web browsers, or be the user interface component of various computing devices including, but not limited to, mobile computing devices, desktop computers, internet terminals, etc. Software in preferred embodiments enable a user to organize all web browser based applications and resources including, but not limited to, video, images, websites, email, instant messaging, video messaging, documents, voice communication, voice messaging, fax, banking, music, etc.

Preferred embodiments of the present invention solve multiple problems including, but not limited to, the following. With a workspace according to preferred embodiments, a user no longer has to remember the location of each application they desire to use. With portable or hosted embodiments, a user is able to easily use their applications with the same preferences, settings, appearance, and interaction that they are accustomed to on any network connected computer, mobile computing device, or internet terminal regardless of its manufacturer and operating system. When using a hosted or portable embodiment, the user's internet/network applications state is maintained across each computer that the user uses to access their workspace. With portable or hosted embodiments, any sensitive data from the user's network applications and network resources is removed from any public computers. When the user logs out of their workspace in preferred embodiments, all of their data, applications, and resources are removed and stored on the workspace hosting server or portable storage. Furthermore, preferred embodiments of the present invention generally eliminate the need to install any local applications on a network connected computer or to store or backup large amounts of files locally on a network connected computer.

With a portable, personal, internet application workspace according to a preferred embodiment of the present invention, the user will have the same experience regardless of which device they are using. They will also have the same preferences and layout, and all of their applications will be in front of them and ready to use. Currently some internet applications store data locally on the user's computer. Usually the applications are in the form of cookies or other supported internet browser temporary files. The workspace in preferred embodiments stores and retrieves these files so that, if the user moves to another computer, the state of the application and its data remain the same as if the user were still working on the same computer. If the workspace in a preferred embodiment is hosted, the workspace and all of the applications and resources may be secured. For example, without limitation, a user can mark their social web pages and images as public and their personal banking applications as private. When the user logs in to the workspace, they can see and interact with all of their applications; however, if someone else accesses the workspace, they are only presented with the user's public applications, in this example the social web pages and images. Preferred embodiments may have any number of security levels to secure the user's content and applications. Since all applications in preferred embodiments are hosted on external servers and no local installation of other applications is required, the device requires much less processing power, storage, and memory to operate than applications running locally on the user's computer. Furthermore, if the software in preferred embodiments is used as the main user interface component of a device, the required size, weight, and cost of the device is greatly decreased than what is required with current operating systems.

All computer and internet users may make use of preferred embodiments of the present invention. Businesses that require their employees to use multiple network applications in their daily tasks may use preferred embodiments to create a workspace for all of their employees with the same applications, settings and preferences in order to give their users the same work environment on multiple devices, which may greatly ease the difficulty of training and support. This enables a company's IT staff to simply configure employees' workspaces and not have to support software installation and configuration of individual computers over their network, since no applications would reside on the computers themselves. A lightweight operating system for an internet terminal or computer could make use of a preferred embodiment as a user interface layer to be run on low cost hardware.

One desired characteristic of preferred embodiments of the present invention is to provide the user with a workspace to organize, layout the user interface of, and record the network location of their network applications and resources. Another desired characteristic of preferred embodiments is to record a user's preferences and the appearance of a workspace. The workspace in preferred embodiments enables customization and expression of the user's own style. For example, without limitation, the workspace may comprise the user's own environment video or image backgrounds, shortcut keys, Human interface device (i.e., mouse, touchpad, keyboard, game controller, etc.) configuration and preferences, etc. Another desired characteristic of preferred embodiments is to enable the user to access their workspace via a network/internet. Another desired characteristic of preferred embodiments is to enable the user to use their workspace on any network/internet connected computer, mobile computing device, or internet terminal regardless of its manufacturer and operating system. Another desired characteristic of preferred embodiments is that the temporary state and data files that the internet/network applications currently save locally on the user's computer are stored and retrieved from a hosting server or portable storage as the user moves to another computer. Another desired characteristic of preferred embodiments is to enable the user to store and access their workspace on a portable storage device including, but not limited to, USB thumb drive, SD card, solid-state drive, portable hard drive, etc. Another desired characteristic of preferred embodiments is to enable the user to install their workspace locally on their computer. Another desired characteristic of preferred embodiments is that the current internet/network applications do not need to be re-designed or re-implemented to any specific application programming interface (API), and current and future applications designed for the Internet and web browsers are and will be able to be presented in this workspace along with a web browser with no additional effort. Another desired characteristic of preferred embodiments is that the software may be the user interface component of a lightweight operating system. The device running this operating system requires only internet/network, limited storage, limited memory, and limited processing power, which all require much less quantity and less cost than typical personal computers. Another desired characteristic of preferred embodiments is that new rendering technologies can be integrated as new rendering components and new network applications can be created to specifically to run within the workspace application to utilize the rendering technologies.

Preferred embodiments of the present invention may be implemented in various different environments. One embodiment is a hosted solution in which the workspace application, configuration, layout, preferences, and data files are hosted on a server. The workspace application can be embedded in a web page or started by directly accessing it via its URI. The application then requests the configuration, layout, and preferences from the server. In the present embodiment, all modifications or additions to the workspace are posted back to the server, and the rendering technologies may be installed on the user's computer as a browser plug-in, may use the user's own web-browser or may be part of the workspace application itself.

Another embodiment is a local solution in which the workspace application is installed locally on the user's computer. The workspace application can be started the same as any other application installed on the computer. After the application is started, the application loads the configuration, layout, preferences, and data files from a local file system or another form of persistent memory. In the present embodiment, all modifications or additions to the workspace are saved back to the file system or other form of persistent memory, and the rendering technologies are internal components of the workspace application or may utilize an already installed web-browser on the user's computer.

Another embodiment is a portable storage solution in which the workspace application, configuration, layout, preferences, and data files are installed on a portable storage device. The portable storage device is connected to a network connected computer when used. The portable storage device can then be moved to another computer and the workspace can be used. The application is started from its installed location on the portable storage device. The workspace application can be started as an application from the storage device or automatically started when the portable storage device is connected. The application then loads the configuration, layout, preferences, and data files from the portable storage device. In the present embodiment, all modifications or additions to the workspace are saved back to the portable storage device, and the rendering technologies are internal components of the workspace application or may utilize an already installed web-browser on the user's computer.

Yet another embodiment is a local application, hosted configuration solution in which the workspace application is installed locally on the user's computer or portable storage device. After the application is started, the application requests the configuration, layout, preferences, and data files from the server. All modifications or additions to the workspace are posted back to the server in the present embodiment.

Yet another embodiment is a user interface component of an operating system in which the operating system is started and the user interface loads the configuration, layout, preferences, and data files from a file system or another form of persistent memory where they are saved. In the present embodiment, all modifications or additions to the workspace are saved back to the file system or other form of persistent memory, and the rendering technologies are internal components of the user interface.

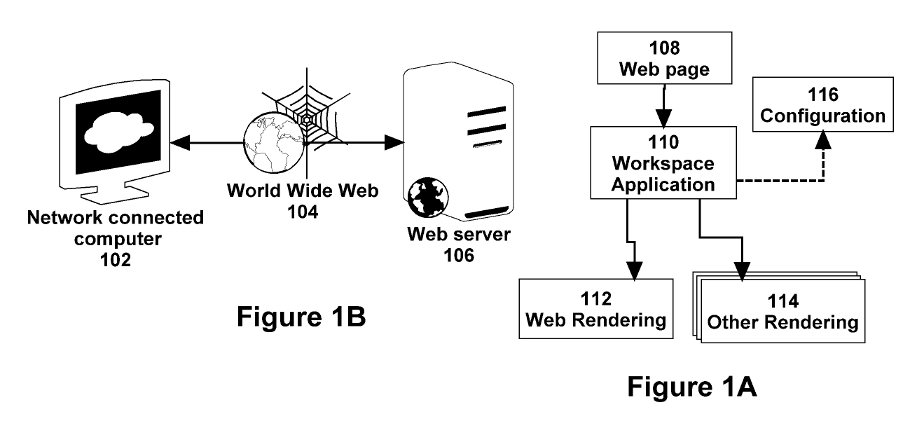

FIGS. 1A and 1B illustrate an exemplary system for providing a workspace application 110 hosted on a server 106, in accordance with an embodiment of the present invention. FIG. 1A is a block diagram showing the components of the exemplary workspace application system, and FIG. 1B shows a computer network on which workspace application 110 may be used. Workspace application 110, along with other units in the system, provides means for presenting to a user, the network applications and network resources within a workspace area where the user can interact with the network applications and network resources to perform tasks. In the present embodiment, several components are hosted on server 106 including, without limitation, workspace application 110, a 116 configuration of workspace application 110, a layout of workspace application 110, preferences, data files, etc. Referring to FIG. 1A, workspace application 110 is dependent on a web rendering component 112, which is responsible for rendering web technologies including, but not limited to, HTML, DHTML, javascript, vbscript, css, xsl, xml, images, videos, etc. Workspace application 110 is also dependent on other rendering components 114, which may include, without limitation, Flash, Silverlight, or any other web presentation technologies. Rendering components 112 and 114 may be installed on a network connected computer 102 as a browser plug-in, may use the user's own web-browser or may be part of workspace application 110 itself. Rendering components 112 and 114 provide means for rendering the network applications and network resources for display in a workspace area of workspace application 110. In the present embodiment, workspace application 110 is embedded in a web page 108. However, in alternate embodiments, the workspace application may be accessed using various different means for example without limitation, starting the workspace application by directly accessing it via its URI, webpage that embeds the workspace, starting another application that embeds the workspace, any network addressable scheme that identifies the workspace, etc.

In the present embodiment, configuration 116 of workspace application 110 comprises many different elements all of which are not necessarily required to be stored, transferred, or requested within the same medium. Configuration 116 comprises any administrator configured attributes including, but not limited to, workspace server and resource locations and user security attributes. Various security attributes can provide means for maintaining security levels for the network applications and network resources. Configuration 116 may also include layout data that comprises a list of network applications to be presented within the workspace along with the network location, user defined security, location within the workspace, size, and other appearance attributes of each network application presentation. Configuration 116 may also include user preferences that comprise workspace wide user configurable attributes including, but not limited to, colors, fonts, shortcut keys, and human interface device configurations. Configuration 116 may also include data files that are used by web rendering component 112 and other rendering components 114 to maintain the network applications in the same state as the user's previous session even if the user uses their workspace on other computers. These data files may also include any files that the user wishes to store along with their workspace which may include, without limitation, images, videos, documents, and applications. The data files may also include, without limitation, the user's URI history and internet cookies. Those skilled in the art, in light of the present teachings, will readily recognize that the configuration of the workspace application may comprise various other types of information and files such as, but not limited to, all aspects of the workspace's user experience: images, video, sounds, music, uploaded documents and files, etc. Configuration 116 provides the user with a means for organizing the network applications and network resources within the workspace area according to stored preferences, maintaining network links to the network applications and network resources, maintaining current states of the network applications and configuring devices according to stored preferences for the user to interact with the network applications and network resources.

Referring to FIG. 1B, all components shown by way of example in FIG. 1A are hosted on a web server 106 in the present embodiment. Workspace application 110 is delivered to network connected computer 102 as a result of a network request. Workspace application 110 then requests configuration 116 from web server 106. The presented network applications are loaded into the workspace with requests via the World Wide Web 104 and visually rendered using web rendering component 112 and other rendering components 114. In alternate embodiments requests to load the network applications may be answered via networks other than the World Wide Web for example, without limitation, LAN, WAN, or any network that the user's computer supports.

In typical use of the present embodiment where workspace application 110 and its components are hosted on a server, a user can access their workspace on any network connected computer 102 with their workspace URI through workspace application 110. The present embodiment provides for various steps for presenting to a user, the network applications and network resources within a workspace area. Workspace application 110 is accessed through web page 108 in the present embodiment; however, in alternate embodiments where the workspace application is not embedded in a web page the workspace application may be accessed by starting another application that embeds the workspace, the workspace URI, any network addressable scheme that identifies the workspace, etc. Workspace application 110 then requests configuration 116, layout, and preferences from server 106 providing steps for organizing the network applications and network resources within a workspace area, maintaining network links, maintaining current states of the network applications and configuring devices. The internet/network resources that the user wishes to be presented within their workspace each have a security attribute specifying what users are allowed to view each resource/application. For example, without limitation, a user may mark their social web pages and images as public, and their personal banking applications as private. When the user logs in, they can see and interact with all of their applications, and when someone else accesses the user's workspace they are only presented with the user's social web pages and images. There could be any number of security levels to secure the user's content and applications for example, without limitation; a 1 through 10 security level may be assigned to an application. Level 1 being least secure and 10 being the most secure. An application may be assigned level 3. This application can be accessed by a user that is assigned level 3 access or higher, while a user assigned level 2 access cannot. Public and private access may be used. The owner of the workspace has access to both public and private secured applications, while any other user has access to only public secured applications. The user is identified by an authentication mechanism, which may include, without limitation, username/password, computer IP address, biometric scanner, etc. Once the user is authenticated, the user is presented with their workspace, which has all of the user's applications and resources presented in the user's preferred layout. The user can access, modify, or delete any of their resources/applications from their workspace and work with their applications. All modifications or additions to the workspace are saved back to server 106. When any of their applications save state data, this data is also saved back to server 106 in order to maintain the same application state if the user chooses to use their workspace on a different computer. All URI history and state data are removed from computer 102 when the user logs out of their workspace and stored on server 106.

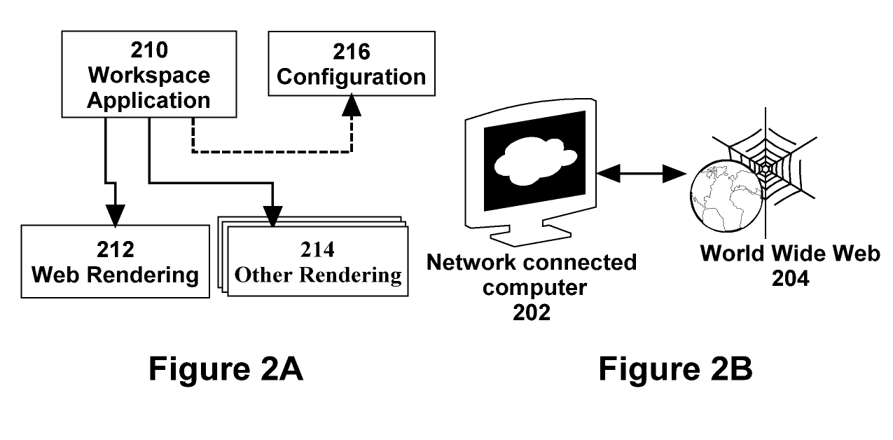

FIGS. 2A and 2B illustrate an exemplary system for providing a workspace application 210 installed locally on a network connected computer 202, in accordance with an embodiment of the present invention. FIG. 2A is a block diagram showing the components of the exemplary workspace application system, and FIG. 2B shows a computer network on which workspace application 210 may be used. In the present embodiment, workspace application 210 is managed along with other locally installed applications, taking place of the user's desktop on network connected computer 202. In alternate embodiments, the workspace application may operate as a typical application on the user's desktop rather than replacing the desktop. Referring to FIG. 2A in the present embodiment, workspace application 210 is dependent on a web rendering component 212, which is responsible for rendering web technologies including, but not limited to, HTML, DHTML, javascript, vbscript, css, xsl, xml, images, and videos. Workspace application 210 is also dependent on other rendering components 214, which may include, without limitation, Flash, Silverlight, or any other web presentation technologies. Rendering components 212 and 214 may be internal components of workspace application 210 or may utilize an already installed web-browser on network connected computer 202.

A configuration 216 of workspace application 210 comprises many different elements all of which are not necessarily required to be stored, transferred, or requested within the same medium. Configuration 216 comprises any administrator configured attributes including, but not limited to, workspace server and resource locations and user security attributes. Configuration 216 may also include layout data that comprises a list of network applications to be presented within the workspace along with the network location, user defined security, location within the workspace, size, and other appearance attributes of each network application presentation. Configuration 216 may also include user preferences that comprise workspace wide user configurable attributes including, but not limited to, colors, fonts, shortcut keys, and human interface device configurations. Configuration 216 may also include data files that are used by web rendering component 212 and other rendering components 214 to maintain the network applications in the same state as the user's previous session even if the user uses their workspace on other computers. The data files may also include, without limitation, any files that the user wishes to store along with their workspace, which may include, without limitation, images, videos, documents, and applications. The data files may also include, without limitation, the user's URI history and internet cookies. Those skilled in the art, in light of the present teachings, will readily recognize that the configuration of the workspace application may comprise various other types of information and files such as, but not limited to, all aspects of the workspace's user experience: images, video, sounds, music, uploaded documents and files, etc.

In typical use of the present embodiment, workspace application 210 can be started as an application installed locally on network connected computer 202. After workspace application 210 is started, workspace application 210 loads configuration 216 including, without limitation, layout, preferences, and data files from a local file system or another form of persistent memory in network connected computer 202. The presented network applications are loaded into the workspace with requests via the World Wide Web 204 and visually rendered using the web rendering component 212 and other rendering components 214. In alternate embodiments requests to load the network applications may be answered via networks other than the World Wide Web for example, without limitation, LAN, WAN, or any network that the user's computer supports. In the present embodiment, all modifications or additions to the workspace are saved back to the file system or other form of persistent memory in network connected computer 202.

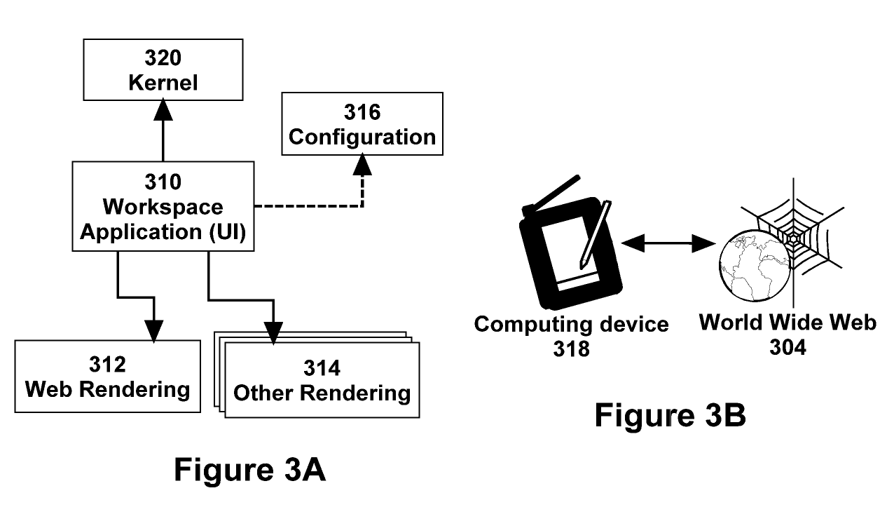

FIGS. 3A and 3B illustrate an exemplary system for providing a workspace application 310 where workspace application 310 is used as a user interface component of an operating system of a computing device 318, in accordance with an embodiment of the preset invention. FIG. 3A is a block diagram showing the components of the exemplary workspace application system, and FIG. 3B shows a network on which workspace application 310 may be used. Referring to FIG. 3A in the present embodiment, workspace application 310 is dependent on a web rendering component 312, which is responsible for rendering web technologies including, but not limited to, HTML, DHTML, javascript, vbscript, css, xsl, xml, images, and videos. Workspace application 310 is also dependent on other rendering components 314, which may include, without limitation, Flash, Silverlight, or any other web presentation technologies. In the present embodiment, rendering components 312 and 314 are internal components of the user interface. Workspace application 310 interacts with an operating system kernel 320 of computing device 318. The workspace user interface of the present embodiment interacts with the kernel through system calls to access random access memory, persistent memory, display hardware, network hardware, and human interface device hardware. These interactions allow the workspace user interface to present the workspace to the user and allow the user to interact with the workspace and all of their applications that are presented within the workspace. A configuration 316 of workspace application 310 comprises many different elements all of which are not necessarily required to be stored, transferred, or requested within the same medium. Configuration 316 comprises any administrator configured attributes including, but not limited to, workspace server and resource locations and user security attributes. Configuration 316 may also include layout data which comprises a list of network applications to be presented within the workspace along with the network location, user defined security, location within the workspace, size, and other appearance attributes of each network application presentation. Configuration 316 may also include user preferences that comprise workspace wide user configurable attributes including, but not limited to, colors, fonts, shortcut keys, and human interface device configurations. Configuration 316 may also include data files that are used by web rendering component 312 and other rendering components 314 to maintain the network applications in the same state as the user's previous session even if the user uses their workspace on other computers. The data files may also include any files that the user wishes to store along with their workspace which may include, without limitation, images, videos, documents, and applications. The data files may also include, without limitation, the user's URI history and internet cookies. Those skilled in the art, in light of the present teachings, will readily recognize that the configuration of the workspace application may comprise various other types of information and files such as, but not limited to, all aspects of the workspace's user experience: images, video, sounds, music, uploaded documents and files, etc.

Referring to FIG. 3B, workspace application 310 loads configuration 316 including, without limitation, layout, preferences and data files from a file system or another form of persistent storage on computing device 318. The presented network applications are loaded into the workspace with requests via the World Wide Web 304 and visually rendered using web rendering component 312 and other rendering components 314. In alternate embodiments requests to load the network applications may be answered via networks other than the World Wide Web for example, without limitation, LAN, WAN, or any network that the user's computer supports. All modifications or additions to the workspace are saved back to the file system or other form of persistent memory on computing device 318. In the present embodiment, each operating system user may have their own workspace or use a shared workspace.

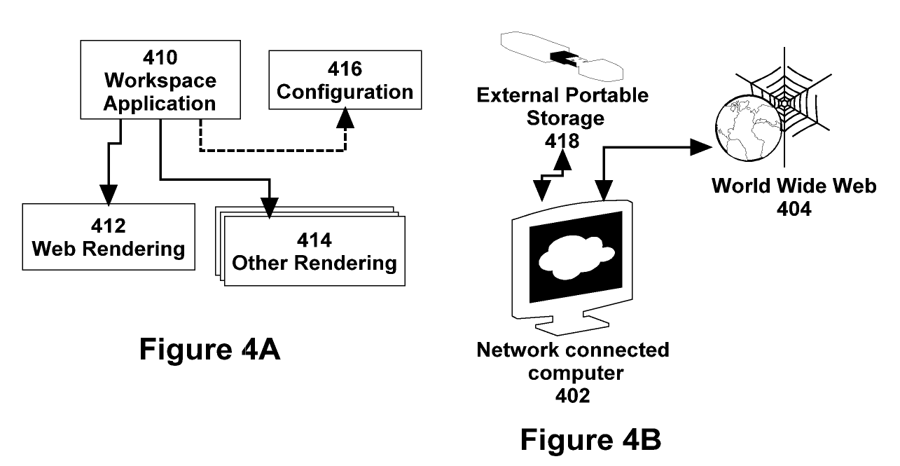

FIGS. 4A and 4B illustrate an exemplary system for providing a workspace application 410 where workspace application 410 is installed on an external portable storage device 418, in accordance with an embodiment of the present invention. FIG. 4A is a block diagram showing the components of the exemplary workspace application system, and FIG. 4B shows a computer network on which workspace application 410 may be used. Referring to FIG. 4A in the present embodiment, workspace application 410 is dependent on a web rendering component 412, which is responsible for rendering web technologies including, but not limited to, HTML, DHTML, javascript, vbscript, css, xsl, xml, images, and videos. Workspace application 410 is also dependent on other rendering components 414, which may include, without limitation, Flash, Silverlight, or any other web presentation technologies. In the present embodiment, rendering components 412 and 414 may be internal components of workspace application 410 or may utilize an already installed web browser on a network connected computer 402. A configuration 416 of workspace application 410 comprises many different elements all of which are not necessarily required to be stored, transferred, or requested within the same medium. A configuration 416 of workplace application 410 comprises any administrator configured attributes including, but not limited to, workspace server and resource locations and user security attributes. Configuration 416 may also include layout data that comprises a list of network applications to be presented within the workspace along with the network location, user defined security, location within the workspace, size, and other appearance attributes of each network application presentation. Configuration 416 may also include user preferences that comprise workspace wide user configurable attributes including, but not limited to, colors, fonts, short cut keys, and human interface device configurations. Configuration 416 may also include data files that are used by web rendering component 412 and other rendering components 414 to maintain the network applications in the same state as the user's previous session even if the user uses their workspace on other computers. The data files may also include any files that the user wishes to be stored along with their workspace, which may include, without limitation, images, videos, documents, and applications. The data files may also include, without limitation, user's URI history, and internet cookies. Those skilled in the art, in light of the present teachings, will readily recognize that the configuration of the workspace application may comprise various other types of information and files such as, but not limited to, all aspects of the workspace's user experience: images, video, sounds, music, uploaded documents and files, etc.

In typical use of the present embodiment, portable storage device 418 is connected to network connected computer 402. Workspace application 410 is started from its installed location on portable storage device 418, and workspace application 410 can be started as an application from portable storage device 418 or automatically started when portable storage device 418 is connected to network connected computer 402. Workspace application 410 then loads its configuration 416 including without limitation, layout, preferences and data files from external portable storage device 418. In the present embodiment, portable storage device 418 may be relatively small; for example, without limitation, a workspace may fit on less than 5 MB of storage. However, larger storage devices may be used. The presented network applications are loaded into the workspace with requests via the World Wide Web 404 and visually rendered using web rendering component 412 and other rendering components 414. In alternate embodiments requests to load the network applications may be answered via networks other than the World Wide Web for example, without limitation, LAN, WAN, or any network that the user's computer supports. In the present embodiment, all modifications or additions to the workspace are saved back to portable storage device 418. Portable storage device 418 can then be moved to another computer and the workspace can be used on that computer.

A basic embodiment of the present invention is an embodiment that is installed on a local computer, which is depicted by way of example in FIGS. 2A and 2B. In this embodiment all components are installed locally on the user's computer. The user configures their workspace as they wish, and each individual computer user has their own workspace that may only be used on the installed computer and may not be transported from computer to computer. The internet/network applications and resources are accessed via their computer's network connection.

Another basic embodiment comprises a computer with a network connection, a workspace application, a configuration of the workspace application, and at least one rendering component or web-browser. The configuration does not exist on the initial install; it is created by the user configuring and customizing their workspace and saved locally on the computer. This embodiment provides a user with a common environment in which to interact with their network/internet resources that is configurable and provides a graphic user interface that enables the user to organize any network/internet based applications that they desire. However, the workspace in the present embodiment is only used on the installed computer and may not be transported from computer to computer.

Preferred embodiments of the present invention present the user with a graphical workspace that the user can customize to their liking. Customizations may include, without limitation, background images, video, games, shortcut keystrokes, mouse and keyboard behavior, web pages, internet applications, pictures, web logs, and internet hosted tools along with locations and sizes of all graphical elements. The user interface for a workspace can be 2 dimensional, 3 dimensional, or even multidimensional, in order for the most intuitive user configured layout.

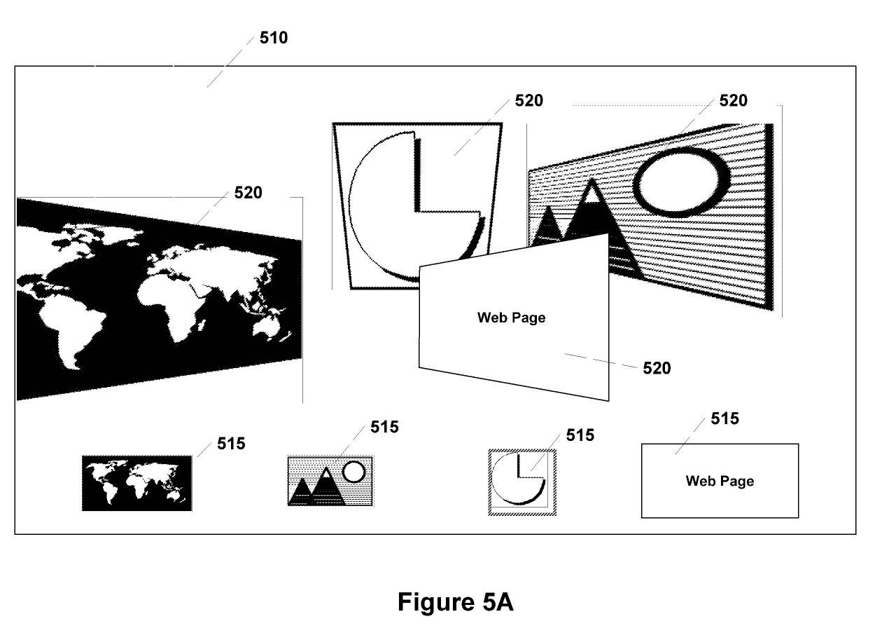

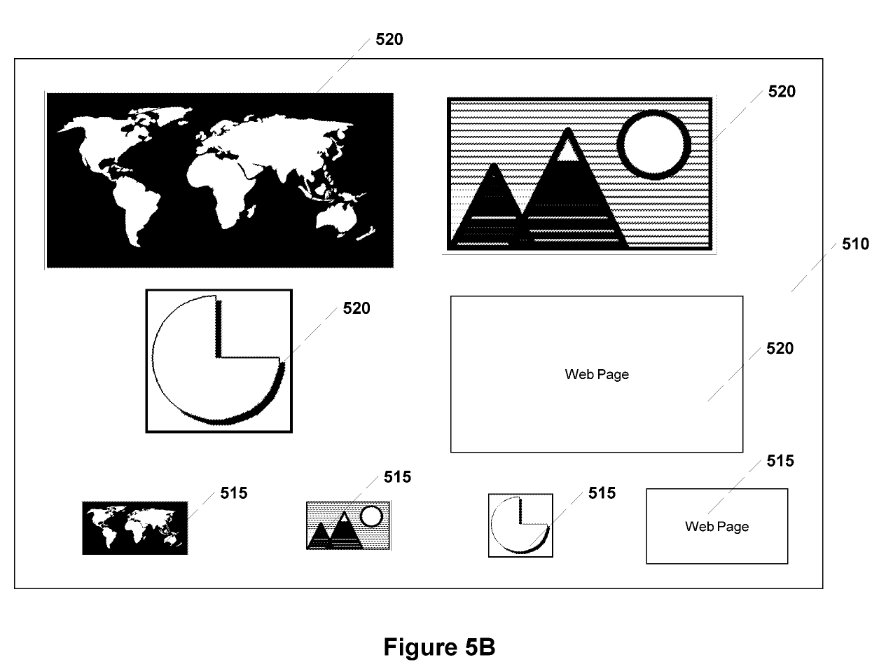

Preferred embodiments of the present invention may be created with current programming languages, tools, libraries, and technology for example, without limitation, C++, C#, VB, Java, JSP, PHP, ASP, Flex, Silverlight, applets, and activeX. In typical use of a preferred embodiment, a user accesses a workspace by entering the URI of their workspace in a computer or web-browser. The user enters their authentication information and is presented with their workspace, which has all of the user's desired applications and network resources presented in the user's preferred layout. The user can modify the layout, add more applications or resources, and work with their applications from the workspace. For example, without limitation, if the user chooses to configure or modify the layout of the workspace, the user can click and drag or use arrow keys to move or resize the applications to the preferred location and size. In preferred embodiments, user interfaces of applications that are installed on the local computer may be presented within the workspace; however, because these applications are locally installed, these applications may not necessarily be portable to other computers. The workspace can have other features to enhance usability including, but not limited to, a task bar, as illustrated by way of example in FIGS. 5A and 5B, a properties menu, an application menu, an appearance menu, a calendar, a clock, simple utility applications like rss reader, calculator, notepad, image viewer, etc.

FIGS. 5A and 5B illustrate exemplary workspace layouts, in accordance with embodiments of the present invention. FIG. 5A shows an exemplary three dimensional workspace layout, and FIG. 5B shows an exemplary two dimensional workspace layout. In the present embodiment, a workspace 510 comprises small graphic representations 515 of each of the applications 520 presented at the bottom of the screen of workspace 510 (i.e., a task bar). In alternate embodiments the task bar may be located in various different positions on the screen for example, without limitation, the top, right or left of the screen. In the present embodiment graphic representations 515 are arranged based on preference; however, in alternate embodiments these representations may be arranged in various different orders for example, without limitation, by order of last use, alphabetically, by frequency of use, etc. In the present embodiment, when one of graphic representations 515 is clicked the corresponding application 520 is brought to the forefront of workspace 510 ready for interaction. The task bar graphic representations 515 have an updated image of the user interface of the corresponding applications 520. This enables the user to see what is happening in all applications 520 without needing to stop work on one application to view the other applications. If the virtual real estate of workspace 510 is too large for the screen of the device on which workspace 510 is being used, the user can navigate through workspace 510 freely with the use of a mouse, keyboard or other human interface device or use graphic representations 515 to immediately retrieve the application they desire.

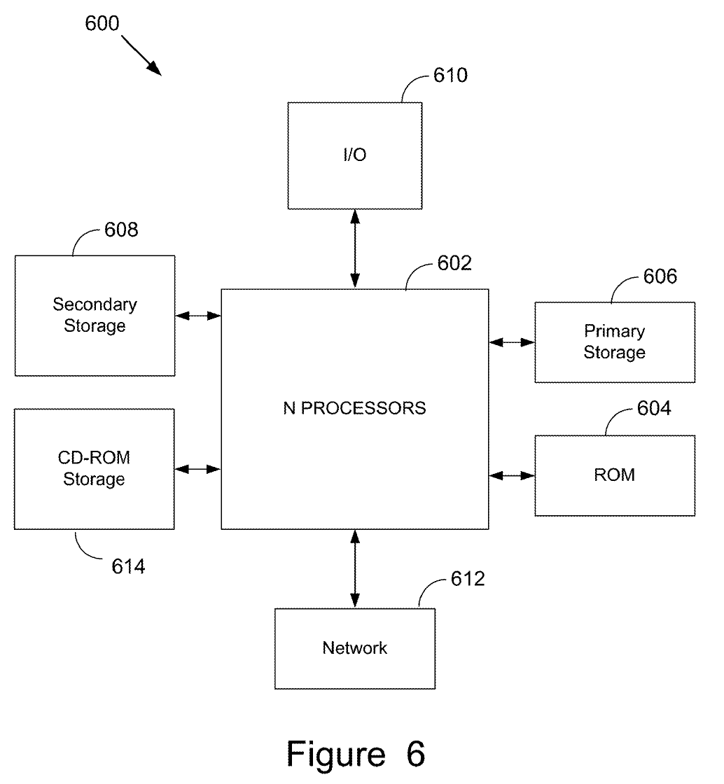

FIG. 6 illustrates a typical computer system that, when appropriately configured or designed, can serve as a computer system in which the invention may be embodied. The computer system 600 includes any number of processors 602 (also referred to as central processing units, or CPUs) that are coupled to storage devices including primary storage 606 (typically a random access memory, or RAM), primary storage 604 (typically a read only memory, or ROM). CPU 602 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 604 acts to transfer data and instructions uni-directionally to the CPU and primary storage 606 is used typically to transfer data and instructions in a bidirectional manner. Both of these primary storage devices may include any suitable computer-readable media such as those described above. A mass storage device 608 may also be coupled bi-directionally to CPU 602 and provides additional data storage capacity and may include any of the computer-readable media described above. Mass storage device 608 may be used to store programs, data and the like and is typically a secondary storage medium such as a hard disk. It will be appreciated that the information retained within the mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 may also be coupled to an interface 610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications or internet network using an external connection as shown generally at 612, which may be implemented as a hardwired or wireless communications link using suitable conventional technologies. With such a connection, it is contemplated that the CPU might receive information from the network, or might output information to the network in the course of performing the method steps described in the teachings of the present invention.

In order for a preferred embodiment of the present invention to optimally operate, there are some recommendations for the network and computer on which it is implemented. It is preferred that the network/internet connection is faster than 56 Kbps. It is preferred that the CPU speed is at least 400 MHz. It is preferred that the computer has at least 256 MB of RAM. However, if the CPU, RAM and connection speed are less than preferred, the workspace will still operate, and the recommended requirements for the network/internet applications and resources that are presented within the workspace may differ. For example, without limitation, if the conditions are less than preferred, the presentation may adapt to still be able to operate. For example, if a 3 dimensional workspace presentation is too intensive for a particular system, the display may adapt to work in a 2 dimensional presentation, and at a very lowest adaptation level, to a text only presentation.

Current web-browsers present a user's network/internet applications and resources in a single window or tabbed window. However, preferred embodiments of the present invention can display all of the user's network/internet applications and resources in a 2D, 3D, or multiple dimensional virtual workspace. Currently, users access their network/internet applications and resources by entering the URI of their application or resource into a web-browser or accessing a shortcut/link that enters the URI for them. However, these shortcut/links reside on the user's computer and are not accessible to other computers. Hosted embodiments of the present invention present the user with all of their network/internet applications and resources, regardless of what computer they are using to accessing them. Current web-browsers save temporary and possibly sensitive information from network/internet applications and resources on the computer where they are executed. However, some preferred embodiments of the present invention remove this sensitive information and save it on a hosted server or portable storage when the workspace is closed. Currently, network/internet applications save state information on the computer where the web-browser is executed, and, when a user accesses the applications from another computer, the previous state information is lost. In contrast, some preferred embodiments of the present invention save and retrieve this state information from a hosted server or portable storage, and the state remains the same if the user moves from computer to computer. Currently, web-browsers and computers where network/internet applications are executed may differ in the ways they are operated, the ways the display appears, and preferences that are configured, requiring the user to learn how to use the different operating systems and web-browsers. Preferred embodiments of the present invention present everything the same way, with the same user preferences regardless of what computer, operating system, or web-browser the user is using.

When used as a user interface of an operating system, a workspace according to a preferred embodiment can operate on a computing device with much less processing power, memory and storage than current operating systems because the network/internet applications that are presented within the workspace are hosted and provide most of the processing on external servers and take minimal resources on the user's computing device to operate. Current computing devices require more processing power, memory and storage because they also have many applications and data that execute on the device itself.

In an alternate embodiment, a workspace may be hosted on a server, and a computer acts as a remote terminal to the workspace session. In this embodiment, the graphical display is transmitted to the computer while all of the mouse and keyboard interactions are transmitted back to the server in order for the user to interact with the applications.

In another alternate embodiment, a workspace could be used as a presentation tool, knowledge repository, collaboration tool, or website. In this embodiment, a user may be charged a fee for access to their hosted workspace. A workspace may have advertising and notices attached and displayed within the workspace.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA. For example, the hosting of the workspace application on a server, and the hosting network applications presented by the workspace, and the network application rendering may be performed and/or located outside of the jurisdiction of the USA while the remaining method steps and/or system components of the forgoing embodiments are typically required to be located/performed in the US for practical considerations.

Having fully described at least one embodiment of the present invention, other equivalent or alternative methods of providing a configurable network application and resource workspace according to the present invention will be apparent to those skilled in the art. The invention has been described above by way of illustration, and the specific embodiments disclosed are not intended to limit the invention to the particular forms disclosed. For example, the particular implementation of the workspace application may vary depending upon the particular type of network used. The workspace applications described in the foregoing were directed to internet based implementations; however, similar techniques are to provide workspace applications for use on other types of networks including, but not limited to, local area networks (LANS), wireless networks, etc. Non-internet based implementations of the present invention are contemplated as within the scope of the present invention. The invention is thus to cover all modifications, equivalents, and alternatives falling within the spirit and scope of the following claims.

What is claimed is:

1. A system for a graphical user interface for network applications and network resources, the system comprising:
a workspace application unit for presenting to a user, the network applications and network resources within a workspace area where the user can interact with the network applications and network resources to perform tasks;
a configuration unit for organizing the network applications and network resources within said workspace area according to stored preferences, and maintaining network links to the network applications and network resources; and
at least one rendering unit for rendering the network applications and network resources for display in said workspace area.

2. The system as recited in claim 1, further comprising additional rendering units for rendering the network applications and network resources for display in said workspace area.

3. The system as recited in claim 1, wherein said configuration unit further maintains current states of the network applications.

4. The system as recited in claim 1, wherein said configuration unit further configures devices according to stored preferences for the user to interact with the network applications and network resources.

5. The system as recited in claim 1, wherein said configuration unit further maintains security levels for the network applications and network resources to control sharing of workspace area between users.

6. The system as recited in claim 1, wherein the network applications and network resources are displayed in a 3-D aspect.

7. The system as recited in claim 1, wherein the interface is hosted by a computing device on a network where said configuration unit stores said preferences, network links, current states on a storage device associated with said computing device, and where the interface can be accessed by a plurality of computing devices on the network to provide a substantially same environment on each of said plurality of computing devices.

8. The system as recited in claim 1, wherein the interface is stored on a persistent portable memory device where said configuration unit stores said preferences, network links, current states on said persistent portable memory device, and where the interface can be accessed by a plurality of computing devices using said persistent portable memory device to provide a substantially same environment on each of said plurality of computing devices.

9. The system as recited in claim 1, wherein the interface serves as a primary interface for an operating system on a computing device.

10. A system for a graphical user interface for network applications and network resources, the system comprising:
means for presenting to a user, the network applications and network resources within a workspace area;
means for organizing the network applications and network resources within said workspace area, maintaining network links; and
means for rendering the network applications and network resources for display in said workspace area.

11. The system as recited in claim 10, further comprising means for maintaining current states of the network applications and configuring devices.

12. The system as recited in claim 10, further comprising means for configuring devices.

13. The system as recited in claim 10, further comprising means for maintaining security levels for the network applications and network resources.

14. The system as recited in claim 10, further comprising means for accessing the interface by a plurality of computing devices on a network to provide a substantially same environment on each of said plurality of computing devices.

15. The system as recited in claim 10, further comprising means for accessing the interface by a plurality of computing devices using a persistent portable memory device to provide a substantially same environment on each of said plurality of computing devices.

16. The system as recited in claim 10, further comprising means for serving as a primary interface for an operating system on a computing device.

17. A method for a graphical user interface for network applications and network resources, the method comprising steps of:
activating a workspace application for presenting to a user, the network applications and network resources within a workspace area where the user can interact with the network applications and network resources to perform tasks;
receiving configuration data for organizing the network applications and network resources within said workspace area according to stored preferences, maintaining network links to the network applications and network resources; and
receiving rendered network applications and network resources for display in said workspace area.

18. The method as recited in claim 17, further comprising the step of receiving rendered network applications and network resources from additional rendering units for display in said workspace area.

19. The method as recited in claim 17, further comprising the step of receiving configuration data for maintaining current states of the network applications.

20. The method as recited in claim 17, further comprising the step of receiving configuration data for configuring devices according to stored preferences for the user to interact with the network applications and network resources.

21. The method as recited in claim 17, further comprising the step of receiving configuration data for maintaining security levels for the network applications and network resources to control sharing of workspace area between users.

22. The method as recited in claim 17, further comprising the step of receiving rendered network applications and network resources for display in a 3-D aspect.

23. The method as recited in claim 17, wherein the interface is hosted by a computing device on a network where the method further comprises the steps of storing and retrieving said configuration data on a storage device associated with said computing device, where a plurality of computing devices can activate said workspace application and receive said configuration data to provide a substantially same environment on each of said plurality of computing devices.

24. The method as recited in claim 17, wherein the interface is stored on a persistent portable memory device where the method further comprises the steps of storing and retrieving said configuration data on said persistent portable memory device, where a plurality of computing devices, using said persistent portable memory device, can activate said workspace application and receive said configuration data to provide a substantially same environment on each of said plurality of computing devices.

25. The method as recited in claim 17, wherein the interface serves as a primary interface for an operating system on a computing device.

26. A method for a graphical user interface for network applications and network resources, the method comprising:
steps for presenting to a user, the network applications and network resources within a workspace area;
steps for organizing the network applications and network resources within said workspace area, maintaining network links; and
steps for displaying the network applications and network resources in said workspace area.

27. The method as recited in claim 26, further comprising steps for maintaining current states of the network applications.

28. The method as recited in claim 26, further comprising steps for configuring devices.

29. The method as recited in claim 26, further comprising steps for maintaining security levels for the network applications and network resources.

30. The method as recited in claim 26, further comprising steps for accessing the interface by a plurality of computing devices on a network to provide a substantially same environment on each of said plurality of computing devices.

31. The method as recited in claim 26, further comprising steps for accessing the interface by a plurality of computing devices using a persistent portable memory device to provide a substantially same environment on each of said plurality of computing devices.

32. The method as recited in claim 26, further comprising steps for serving as a primary interface for an operating system on a computing device.

33. A graphical user interface for network applications and network resources, the interface comprising:
a workspace application unit for presenting to a user, the network applications and network resources within a workspace area where the user can interact with the network applications and network resources to perform tasks;
a configuration unit for organizing the network applications and network resources within said workspace area according to stored preferences, maintaining network links to the network applications and network resources; and
at least one rendering unit for rendering the network applications and network resources for display in said workspace area.

34. The interface as recited in claim 33, further comprising additional rendering units for rendering the network applications and network resources for display in said workspace area.

35. The interface as recited in claim 33, wherein said configuration unit further maintains current states of the network applications.

36. The interface as recited in claim 33, wherein said configuration unit further configures devices according to stored preferences for the user to interact with the network applications and network resources

37. The interface as recited in claim 33, wherein said configuration unit further maintains security levels for the network applications and network resources to control sharing of workspace area between users.

38. The interface as recited in claim 33, wherein the network applications and network resources are displayed in a 3-D aspect.

39. The interface as recited in claim 33, wherein the interface is hosted by a computing device on a network where said configuration unit stores said preferences, network links, current states on a storage device associated with said computing device, and where the interface can be accessed by a plurality of computing devices on the network to provide a substantially same environment on each of said plurality of computing devices.

40. The interface as recited in claim 33, wherein the interface is stored on a persistent portable memory device where said configuration unit stores said preferences, network links, current states on said persistent portable memory device, and where the interface can be accessed by a plurality of computing devices using said persistent portable memory device to provide a substantially same environment on each of said plurality of computing devices.

41. The interface as recited in claim 33, wherein the interface serves as a primary interface for an operating system on a computing device.

42. A graphical user interface for network applications and network resources, the interface comprising:
means for presenting to a user, the network applications and network resources within a workspace area;
means for organizing the network applications and network resources within said workspace area, maintaining network links; and
means for rendering the network applications and network resources for display in said workspace area.

43. The interface as recited in claim 42, further comprising means for maintaining current states of the network applications.

44. The interface as recited in claim 42, further comprising means for configuring devices.

45. The interface as recited in claim 42, further comprising means for maintaining security levels for the network applications and network resources.

46. The interface as recited in claim 42, further comprising means for accessing the interface by a plurality of computing devices on a network to provide a substantially same environment on each of said plurality of computing devices.

47. The interface as recited in claim 42, further comprising means for accessing the interface by a plurality of computing devices using a persistent portable memory device to provide a substantially same environment on each of said plurality of computing devices.

48. The interface as recited in claim 42, further comprising means for serving as a primary interface for an operating system on a computing device.

49. A computer program product for a graphical user interface for network applications and network resources, the computer program product comprising:
computer code for presenting to a user, the network applications and network resources within a workspace area where the user can interact with the network applications and network resources to perform tasks;
computer code for organizing the network applications and network resources within said workspace area according to stored preferences, maintaining network links to the network applications and network resources;
computer code for displaying rendered network applications and network resources in said workspace area; and
a computer-readable medium for storing said computer code.

50. The computer program product as recited in claim 49, further comprising computer code for displaying network applications and network resources, rendered from a plurality rendering units, in said workspace area.

51. The computer program product as recited in claim 49, further comprising computer code for maintaining current states of the network applications.

52. The computer program product as recited in claim 49, further comprising computer code for configuring devices according to stored preferences for the user to interact with the network applications and network resources.

53. The computer program product as recited in claim 49, further comprising computer code for maintaining security levels for the network applications and network resources to control sharing of workspace area between users.

54. The computer program product as recited in claim 49, further comprising computer codes for displaying rendered network applications and network resources in said workspace area in a 3-D aspect.

55. The computer program product as recited in claim 49, wherein the computer program product is hosted by a computing device on a network where the computer program product further comprises computer code for storing and retrieving configuration data on a storage device associated with said computing device, where a plurality of computing devices can access the computer program product and receive said configuration data to provide a substantially same environment on each of said plurality of computing devices.

56. The computer program product as recited in claim 49, wherein the computer program product is stored on a persistent portable memory device and the computer program product further comprises computer code for storing and retrieving configuration data on said persistent portable memory device where a plurality of computing devices, using said persistent portable memory device, can access the computer program product and receive said configuration data to provide a substantially same environment on each of said plurality of computing devices.

57. The method as recited in claim 49, wherein the computer program product serves as a primary interface for an operating system on a computing device and the computer program product further comprises computer code for communicating with a kernel of said operating system.
